(19) United States
(12) Patent Application Publication
(10) Pub. No.: US 2025/0243114 A1
(43) Pub. Date: Jul. 31, 2025

(54) GLASS FIBER REINFORCED GYPSUM BOARDS AND METHODS OF MAKING THEM

(71) Applicant: Certainteed Gypsum, Inc., Malvern, PA (US)

(72) Inventors: Dahlia AMATO, Malvern, PA (US); Remi Lespiat, Devon, PA (US); Lea Ernoult, Paris (FR); Roger Jones, Fleming Island, FL (US); Serge Adjoua, Mason, OH (US)

(21) Appl. No.: 19/042,067

(22) Filed: Jan. 31, 2025

Related U.S. Application Data
(60) Provisional application No. 63/627,663, filed on Jan. 31, 2024.

(30) Foreign Application Priority Data
Mar. 18, 2024 (EP) 24305404.6

(51) Int. Cl. C04B 20/10; C04B 14/42; C04B 28/14; C04B 111/00

(52) U.S. Cl. CPC C04B 20/1033; C04B 14/42; C04B 20/1051; C04B 28/14; C04B 2111/00612; C04B 2201/20

(57) ABSTRACT

According to one embodiment, a gypsum-based slurry composition is disclosed. The gypsum-based slurry composition can include a precursor stucco component, a precursor reinforcement component comprising glass fibers coated with a glass fiber coating. The glass fiber coating can comprise PVOH, PVAC, hydrophilic silane, or a combination thereof.

### CROSS-REFERENCE TO RELATED APPLICATION(S)

This Application claims priority under 35 U.S.C. § 119(e) to U.S. Provisional Patent Application No. 63/627,663, entitled “GLASS FIBER REINFORCED GYPSUM BOARDS AND METHODS OF MAKING THEM,” by Dahlia AMATO et al., filed Jan. 31, 2024, and also claims priority to European Patent Application No. 24305404.6, entitled “GLASS FIBER REINFORCED GYPSUM BOARDS AND METHODS OF MAKING THEM,” by Dahlia AMATO et al., filed Mar. 18, 2024, both of which are assigned to the current assignee hereof and are incorporated herein by reference in their entireties.

### FIELD OF THE DISCLOSURE

The present disclosure relates to glass fiber reinforced gypsum boards and methods of making the same.

### BACKGROUND

Gypsum building products (e.g., known variously as wallboard, ceiling board, plasterboard and “drywall”) are panels made of a gypsum core sandwiched between two layers of liner, often paper, on the outside surfaces of the gypsum core. They are widely used as construction materials due to their ease of fabrication, high mechanical strength, low thermal conductivity, resistance to spread of fire, and soundproofing properties. The quality of a gypsum board is strongly dependent on its gypsum core, which is fabricated by the hydration of stucco slurry (mainly containing calcium sulfate hemihydrate) into a set body of calcium sulfate dihydrate. To control the properties of gypsum boards, additives are often added to the stucco slurry during the board making process. For example, foaming agents, inorganic compounds, and other additives may be included in the slurry to modulate the density, strength, and/or fire resistance properties of the board.

Glass fibers can be included to reinforce gypsum boards. The glass fibers can include a coating or sizing. Different glass fibers interface differently with gypsum compositions. There is a need in the art to find methods and compositions that allow for improved glass fiber-gypsum interfaces.

### SUMMARY

According to one embodiment, a gypsum-based slurry composition is disclosed. The gypsum-based slurry composition can include a precursor stucco component, a precursor reinforcement component comprising glass fibers coated with a glass fiber coating. The glass fiber coating can comprise PVOH, PVAC, hydrophilic silane, or a combination thereof.

According to a further embodiment, a gypsum-based construction material is disclosed. Such gypsum-based construction material is preferably made by a method as defined herein. The gypsum-based construction material can include a gypsum core. The gypsum core can include a gypsum component, and a reinforcement component comprising glass fibers coated with a glass fiber coating. The glass fiber coating can comprise PVOH, PVAC, hydrophilic silane, or a combination thereof. The gypsum-based construction material can include a flexural strength of at least about 30.0 lbf according to a modified flexural strength test as described in the examples section of this application.

According to a further embodiment, a method of forming a gypsum-based construction material is disclosed. The method can include providing a gypsum-based slurry composition as defined herein, depositing the slurry composition to form a gypsum core of the gypsum-based construction material preform, and drying the gypsum core of the gypsum-based construction material.

### BRIEF DESCRIPTION OF THE DRAWINGS

The present disclosure may be better understood, and its numerous features and advantages made apparent to those skilled in the art by referencing the accompanying drawings.

FIG. 1 is an illustration of a gypsum board as described herein.

FIGS. 2a-g include images of the interface between gypsum and glass fiber sizings for exemplary and conventional gypsum boards.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The use of the word “about,” “approximately,” or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the construction products arts.

Various embodiments of the present disclosure will now be described, by way of example only, with reference to the accompanying drawings.

The present inventors have developed a method of producing a glass fiber reinforced board with an improved interface between the gypsum and the glass fiber coating.

The present disclosure is concerned with fiber reinforced gypsum boards comprising a gypsum core and methods for making them. As such, in one embodiment, the present disclosure a method for producing a gypsum board comprising a gypsum core. The method may comprise providing a gypsum-based slurry composition comprising a precursor stucco component, and a precursor reinforcement component comprising glass fibers coated with a glass fiber coating, the glass fiber coating comprising PVOH, PVAC, hydrophilic silane, or a combination thereof.

In an embodiment, the precursor stucco component may have a particular composition that may facilitate improved performance and/or manufacturing of the gypsum-based construction material. In an embodiment, the gypsum-based slurry composition may comprise calcium sulfate hemihydrate.

In an embodiment, the gypsum-based slurry composition may include a particular content of the precursor stucco component that may facilitate improved performance and/or manufacturing of the gypsum-based construction material. In an embodiment, the gypsum-based slurry composition may comprise the precursor stucco component at a content of at least about 10 wt. % for a total weight of the gypsum-based slurry composition. In an embodiment, the gypsum-based slurry composition may comprise the precursor stucco component at a content of not greater than about 95 wt. % for a total weight of the gypsum-based slurry composition or not greater than about 90 wt. % or not greater than about 80 wt. % or not greater than about 70 wt. % or not greater than about 60 wt. % or not greater than about 50 wt. %. It will be appreciated that precursor stucco component content may be between any of the minimum and maximum values noted above.

In an embodiment, the gypsum-based slurry composition may include a particular content of the precursor reinforcement component that may facilitate improved performance and/or manufacturing of the gypsum-based construction material. In an embodiment, the gypsum-based slurry composition may comprise the precursor reinforcement component at a content of at least about 0.03 wt. % relative to the weight of the precursor stucco component. In an embodiment, the gypsum-based slurry composition may comprise the precursor reinforcement component at a content of not greater than about 10 wt. % relative to the weight of the precursor stucco component. It will be appreciated that precursor reinforcement component content may be between any of the minimum and maximum values noted above.

In an embodiment, the precursor reinforcement component may include fibers coated with a particular glass fiber coating that may facilitate improved performance and/or manufacturing of the gypsum-based construction material. In an embodiment, the glass fiber coating can comprise a combination of PVOH and PVAC. In an embodiment, the glass fiber coating can comprise hydrophilic silane.

In an embodiment, the glass fiber coating may have a particular coating slump factor that may facilitate improved performance and/or manufacturing of the gypsum-based construction material. In an embodiment the glass fiber coating may comprise a coating slump factor S_{c} of greater than 0.98 in or at least 0.985 in. or at least 0.99 in. In an embodiment the glass fiber coating may comprise a coating slump factor S_{c} of not greater than 1.5 in. It will be appreciated that coating slump factor S_{c} may be between any of the minimum and maximum values noted above. The procedure for determining coating slump factor is detailed in the examples section of this application.

In an embodiment, the gypsum-based slurry composition may have a particular slurry slump factor that may facilitate improved performance and/or manufacturing of the gypsum-based construction material. In an embodiment the gypsum-based slurry composition may comprise slurry slump factor Sₛ of at least 9.3 in. or at least 9.35 in. or at least 9.4 in. or at least 9.45 in. or at least 9.5 in. or at least 9.55 in. or at least 9.6 in. In an embodiment the gypsum-based slurry composition may comprise a slurry slump factor Sₛ of not greater than 10. It will be appreciated that slurry slump factor Sₛ may be between any of the minimum and maximum values noted above. The procedure for determining slurry slump factor is detailed in the examples section of this application.

In an embodiment, the glass fiber coating may have a particular contact angle C_{c} that may facilitate improved performance and/or manufacturing of the gypsum-based construction material. In an embodiment the glass fiber coating may comprise contact angle factor C_{c} of no greater than 54° or no greater than 53.5° or no greater than 53° or no greater than 52.5° or no greater than 52° or no greater than 51.5° or no greater than 51°. In an embodiment the glass fiber coating may comprise a coating contact angle factor C_{c} of at least 40°. It will be appreciated that coating contact angle factor C_{c} may be between any of the minimum and maximum values noted above. The procedure for determining contact angle factor is detailed in the examples section of this application.

In an embodiment, the gypsum-based slurry composition may include a second precursor reinforcement component. The second precursor reinforcement component is a different precursor reinforcement component than the first precursor reinforcement component, and may be made from the same or different materials. The second precursor reinforcement component may comprise glass fiber. In an embodiment, the gypsum-based slurry composition may include a particular content of the second precursor reinforcement component that may facilitate improved performance and/or manufacturing of the gypsum-based construction material. In an embodiment, the gypsum-based slurry composition may comprise the second precursor reinforcement component at a content of at least about 0.03 wt. % relative to the weight of the precursor stucco component. In an embodiment, the gypsum-based slurry composition may comprise the second precursor reinforcement component at a content of not greater than about 10 wt. % relative to the weight of the precursor stucco component. It will be appreciated that second precursor reinforcement component content may be between any of the minimum and maximum values noted above.

In an embodiment, the gypsum-based slurry composition may further comprise a precursor starch component. The precursor starch component may comprise a particular material that may facilitate improved performance and/or manufacturing of the gypsum-based construction material. In an embodiment, the precursor starch component can comprise an acid modified starch, a chemically modified starch, a natural starch, such as, a corn starch, a sorghum starch, a wheat starch, a tapioca starch, a rice starch, a pea starch, a potato starch, a maize starch, or any combination thereof.

In an embodiment, the gypsum-based slurry composition may include a particular content of the precursor starch component that may facilitate improved performance and/or manufacturing of the gypsum-based construction material. In an embodiment, the gypsum-based slurry composition may comprise the precursor starch component at a content of at least about 0.001 wt. % relative to the weight of the precursor stucco component. In an embodiment, the gypsum-based slurry composition may comprise the precursor starch component at a content of not greater than about 1.5 wt. % relative to the weight of the precursor stucco component. It will be appreciated that precursor starch component content may be between any of the minimum and maximum values noted above.

In an embodiment, the gypsum-based slurry composition may further comprise a

precursor accelerator component. The precursor accelerator component may comprise a particular material that may facilitate improved performance and/or manufacturing of the gypsum-based construction material. In an embodiment, the precursor accelerator component can comprise a heat resistant gypsum accelerator.

In an embodiment, the gypsum-based slurry composition may include a particular content of the precursor accelerator component that may facilitate improved performance and/or manufacturing of the gypsum-based construction material. In an embodiment, the gypsum-based slurry composition may comprise the precursor accelerator component at a content of at least about 0.1 wt. % relative to the weight of the precursor stucco component. In an embodiment, the gypsum-based slurry composition may comprise the precursor accelerator component at a content of not greater than about 5.0 wt. % relative to the weight of the precursor stucco component. It will be appreciated that precursor accelerator component content may be between any of the minimum and maximum values noted above.

In an embodiment, the gypsum-based slurry composition may further comprise a precursor guar gum component. The precursor guar gum component may comprise a particular material that may facilitate improved performance and/or manufacturing of the gypsum-based construction material. In an embodiment, the precursor guar gum component can comprise a native guar gum, a chemically modified guar gum, or any combination thereof.

In an embodiment, the gypsum-based slurry composition may further comprise a precursor fluidizing agent component. The precursor fluidizing agent component may comprise a particular material that may facilitate improved performance and/or manufacturing of gypsum-based construction material. In an embodiment, the precursor fluidizing agent component can comprise a polynaphthalene sulfonate, ligno sulfonate, polyaryl ether, poly carboxylate or any combination thereof.

In an embodiment, the gypsum-based slurry composition may include a particular content of the precursor fluidizing agent component that may facilitate improved performance and/or manufacturing of the gypsum-based construction material. In an embodiment, the gypsum-based slurry composition may comprise the precursor fluidizing agent component at a content of at least about 0.1 wt. % relative to the weight of the precursor stucco component. In an embodiment, the gypsum-based slurry composition may comprise the precursor fluidizing agent component at a content of not greater than about 1 wt. % relative to the weight of the precursor stucco component. It will be appreciated that precursor fluidizing agent component content may be between any of the minimum and maximum values noted above.

In an embodiment, the gypsum-based slurry composition may further comprise water.

In an embodiment, the gypsum-based slurry composition may further comprise a precursor retardant component.

In an embodiment, the gypsum-based slurry composition may further comprise water precursor foam component.

In an embodiment, a second gypsum-based slurry composition may be deposited over the gypsum-based slurry composition. The second gypsum-based slurry composition is a different composition than the first gypsum-based slurry composition and may be made from the same or different materials. The second gypsum-based slurry composition may comprise a second precursor stucco component and water. The second precursor stucco component is a different precursor stucco component than the first precursor stucco component and may be made from the same or different materials. In an embodiment, the gypsum-based slurry composition may comprise calcium sulfate hemihydrate.

In an embodiment, the second gypsum-based slurry composition may include a particular content of the second precursor stucco component that may facilitate improved performance and/or manufacturing of the gypsum-based construction material. In an embodiment, the second gypsum-based slurry composition may comprise the second precursor stucco component at a content of at least about 10 wt. % for a total weight of the second gypsum-based slurry composition. In an embodiment, the second gypsum-based slurry composition may comprise the precursor stucco component at a content of not greater than about 95 wt. % for a total weight of the gypsum-based slurry composition or not greater than about 90 wt. % or not greater than about 80 wt. % or not greater than about 70 wt. % or not greater than about 60 wt. % or not greater than about 50 wt. %. It will be appreciated that second precursor stucco component content may be between any of the minimum and maximum values noted above.

In an embodiment, the second gypsum-based slurry composition may include third precursor reinforcement component. The third reinforcement component may comprise glass fibers. The glass fibers may be coated with a third glass fiber coating. The third precursor reinforcement component is a different precursor reinforcement component than the first or second precursor reinforcement and may be made from the same or different materials.

In an embodiment, the second gypsum-based slurry composition may include a particular content of the third precursor reinforcement component that may facilitate improved performance and/or manufacturing of the gypsum-based construction material. In an embodiment, the second gypsum-based slurry composition may comprise the third precursor reinforcement component at a content of at least about 0.03 wt. % relative to the weight of the second precursor stucco component. In an embodiment, the second gypsum-based slurry composition may comprise the third precursor reinforcement component at a content of not greater than about 10 wt. % relative to the weight of the second precursor stucco component. It will be appreciated that third precursor reinforcement component content may be between any of the minimum and maximum values noted above.

In an embodiment, the second gypsum-based slurry composition may include a particular third glass fiber coating that may facilitate improved performance and/or manufacturing of the gypsum-based construction material. In an embodiment, the third glass fiber coating can comprise PVOH, PVAC, or a combination thereof. In an embodiment, the third glass fiber coating can comprise a combination of PVOH and PVAC. In an embodiment, the third glass fiber coating can comprise hydrophilic silane.

In an embodiment, the third glass fiber coating may have a particular coating slump factor that may facilitate improved performance and/or manufacturing of the gypsum-based construction material. In an embodiment the third glass fiber coating may comprise a coating slump factor S_{c} of greater than 0.98 in or at least 0.985 in or at least 0.99 in. In an embodiment the third glass fiber coating may comprise a coating slump factor S_{c} of not greater than 1.5 in. It will be appreciated that coating slump factor S_{c} may be between any of the minimum and maximum values noted above. The procedure for determining coating slump factor is detailed in the examples section of this application.

In an embodiment, the second gypsum-based slurry composition may have a particular slurry slump factor that may facilitate improved performance and/or manufacturing of the gypsum-based construction material. In an embodiment the second gypsum-based slurry composition may comprise slurry slump factor Sₛ of at least 9.3 in. or at least 9.35 in. or at least 9.4 in. or at least 9.45 in. or at least 9.5 in. or at least 9.55 in. or at least 9.6 in. In an embodiment the second gypsum-based slurry composition may comprise a slurry slump factor Sₛ of not greater than 10. It will be appreciated that slurry slump factor Sₛ may be between any of the minimum and maximum values noted above. The procedure for determining slurry slump factor is detailed in the examples section of this application.

In an embodiment, the third glass fiber coating may have a particular contact angle C_{c} that may facilitate improved performance and/or manufacturing of the gypsum-based construction material. In an embodiment the third glass fiber coating may comprise contact angle factor C_{c} of no greater than 54° or no greater than 53.5° or no greater than 53° or no greater than 52.5° or no greater than 52° or no greater than 51.5° or no greater than 51°. In an embodiment the third glass fiber coating may comprise a coating contact angle factor C_{c} of at least 40°. It will be appreciated that coating contact angle factor C_{c} may be between any of the minimum and maximum values noted above. The procedure for determining contact angle factor is detailed in the examples section of this application.

In an embodiment, the second gypsum-based slurry composition may include a fourth precursor reinforcement component. The fourth precursor reinforcement component may comprise glass fibers. In an embodiment, the second gypsum-based slurry composition may include a particular content of the fourth precursor reinforcement component that may facilitate improved performance and/or manufacturing of the gypsum-based construction material. In an embodiment, the second gypsum-based slurry composition may comprise the fourth precursor reinforcement component at a content of at least about 0.03 wt. % relative to the weight of the second precursor stucco component. In an embodiment, the second gypsum-based slurry composition may comprise the fourth precursor reinforcement component at a content of not greater than about 10 wt. % relative to the weight of the second precursor stucco component. It will be appreciated that the fourth precursor reinforcement component content may be between any of the minimum and maximum values noted above.

In an embodiment, the second gypsum-based slurry composition may include a second precursor retardant component, a second precursor accelerator component, a second precursor fluidizing agent, a second precursor starch component, or a combination thereof. The a second precursor retardant component, a second precursor accelerator component, a second precursor fluidizing agent, a second precursor starch component are different components than first precursor retardant component, the first precursor accelerator component, the first precursor fluidizing agent, and/or the first precursor starch component, and may be made from the same or separate materials. The second gypsum-based slurry composition may be denser than the gypsum-based slurry composition. The second gypsum-based slurry composition may not comprise a foaming agent. The second gypsum-based slurry composition may be the same composition as the gypsum-based slurry composition. The second gypsum-based slurry composition may be different than composition as the gypsum-based slurry composition. The second gypsum-based slurry composition may be the same composition as the gypsum-based slurry composition but without the foaming agent.

In an embodiment, the aforementioned gypsum-based slurry composition or compositions may be deposited to form a gypsum preform of a gypsum-based construction material preform. The gypsum preform can then be dried to make a gypsum core, converting the precursor stucco component into a gypsum component. In an embodiment, the gypsum core may comprise a gypsum component and a reinforcement component comprising glass fibers coated with a glass fiber coating, the glass fiber coating comprising PVOH, PVAC, hydrophilic silane, or a combination thereof.

In an embodiment, the aforementioned gypsum-based slurry composition may be casted to form a gypsum-based construction material such as, a panel, a board, walls, plinths, slabs, columns, sheets, casts or shafts.

In an embodiment, the gypsum core may include a particular content of the gypsum component that may facilitate improved performance and/or manufacturing of the gypsum core. In an embodiment, the gypsum core may comprise the gypsum component at a content of at least about 60 wt. % for a total weight of the gypsum core. In an embodiment, the gypsum core may comprise the gypsum component at a content of not greater than about 98 wt. % for a total weight of the gypsum-core. It will be appreciated that gypsum component content may be between any of the minimum and maximum values noted above.

In an embodiment, the gypsum core may include a particular content of the reinforcement component that may facilitate improved performance and/or manufacturing of the gypsum-based construction material. In an embodiment, the gypsum core may comprise the reinforcement component at a content of at least about 0.03 wt. % relative to the weight of the gypsum component. In an embodiment, the gypsum core may comprise the reinforcement component at a content of not greater than about 10 wt. % relative to the weight of the gypsum component. It will be appreciated that reinforcement component content may be between any of the minimum and maximum values noted above.

In an embodiment, the gypsum core may include a particular glass fiber coating that may facilitate improved performance and/or manufacturing of the gypsum-based construction material. In an embodiment, the glass fiber coating can comprise a combination of PVOH and PVAC. In an embodiment, the glass fiber coating can comprise hydrophilic silane.

In an embodiment, the glass fiber coating may have a particular coating slump factor that may facilitate improved performance and/or manufacturing of the gypsum-based construction material. In an embodiment the glass fiber coating may comprise a coating slump factor S_{c} of greater than 0.98 in or at least 0.985 in. or at least 0.99 in. In an embodiment the glass fiber coating may comprise a coating slump factor S_{c} of not greater than 1.5 in. It will be appreciated that coating slump factor S_{c} may be between any of the minimum and maximum values noted above. The procedure for determining coating slump factor is detailed in the examples section of this application.

In an embodiment, the glass fiber coating may have a particular contact angle C_{c} that may facilitate improved performance and/or manufacturing of the gypsum-based construction material. In an embodiment the glass fiber coating may comprise contact angle factor C_{c} of no greater than 54° or no greater than 53.5° or no greater than 53° or no greater than 52.5° or no greater than 52° or no greater than 51.5° or no greater than 51°. In an embodiment the glass fiber coating may comprise a coating contact angle factor C_{c} of at least 40°. It will be appreciated that coating contact angle factor C_{c} may be between any of the minimum and maximum values noted above. The procedure for determining contact angle factor is detailed in the examples section of this application.

In an embodiment, the gypsum-based construction material can include a second gypsum layer comprising a second gypsum component. The second gypsum layer is a different layer than the first gypsum layer and may be made of the same or a different material. The second gypsum component is a different component than the first gypsum component and may be made of the same or a different material. The second gypsum layer can further include a third reinforcement component. The third reinforcement component is a different component than the first and second reinforcement components and may be made from the same or different materials. The third reinforcement component can include third glass fibers and a third glass fiber coating. The third glass fibers are different glass fibers than the first and second glass fibers and may be made from the same or different materials. The third glass fiber coating is a different glass fiber coating than the first glass fiber coating and may be made from the same or different materials.

In an embodiment, the second gypsum layer may include a particular content of the second gypsum component that may facilitate improved performance and/or manufacturing of the gypsum-based construction material. In an embodiment, the second gypsum layer may comprise the second gypsum component at a content of at least about 60 wt. % for a total weight of the second gypsum layer. In an embodiment, the second gypsum layer may comprise the gypsum component at a content of not greater than about 98 wt. % for a total weight of the second gypsum layer. It will be appreciated that second gypsum component content may be between any of the minimum and maximum values noted above.

In an embodiment, the second gypsum layer may include a particular content of the third reinforcement component that may facilitate improved performance and/or manufacturing of the gypsum-based construction material. In an embodiment, the second gypsum layer may comprise the third reinforcement component at a content of at least about 0.03 wt. % relative to the weight of the second gypsum component. In an embodiment, the second gypsum layer may comprise the third reinforcement component at a content of not greater than about 10 wt. % relative to the weight of the second gypsum component. It will be appreciated that reinforcement component content may be between any of the minimum and maximum values noted above.

In an embodiment, the second gypsum layer may include a particular third glass fiber coating that may facilitate improved performance and/or manufacturing of the gypsum-based construction material. In an embodiment, the third glass fiber coating can comprise PVOH, PVAC, hydrophilic silane, or a combination thereof. In an embodiment, the third glass fiber coating can comprise a combination of PVOH and PVAC. In an embodiment, the third glass fiber coating can comprise hydrophilic silane.

In an embodiment, the third glass fiber coating may have a particular coating slump factor that may facilitate improved performance and/or manufacturing of the gypsum-based construction material. In an embodiment the third glass fiber coating may comprise a coating slump factor S_{c} of greater than 0.98 in. or at least 0.985 in. or at least 0.99 in. In an embodiment the third glass fiber coating may comprise a coating slump factor S_{c} of not greater than 1.5 in. It will be appreciated that coating slump factor S_{c} may be between any of the minimum and maximum values noted above. The procedure for determining coating slump factor is detailed in the examples section of this application.

In an embodiment, the third glass fiber coating may have a particular contact angle C_{c} that may facilitate improved performance and/or manufacturing of the gypsum-based construction material. In an embodiment the third glass fiber coating may comprise contact angle factor C_{c} of no greater than 54° or no greater than 53.5° or no greater than 53° or no greater than 52.5° or no greater than 52° or no greater than 51.5° or no greater than 51°. In an embodiment the third glass fiber coating may comprise a coating contact angle factor C_{c} of at least 40°. It will be appreciated that coating contact angle factor C_{c} may be between any of the minimum and maximum values noted above. The procedure for determining contact angle factor is detailed in the examples section of this application.

In an embodiment, the second gypsum layer may include a fourth reinforcement component, a second retardant component, a second accelerator component, a second fluidizing agent, a second starch component, or a combination thereof. The a second retardant component, a second accelerator component, a second fluidizing agent, a second starch component are different components than the first retardant component, the first accelerator component, the first fluidizing agent, and/or the first starch component, and may be made from the same or separate materials

In an embodiment, the second gypsum layer may be denser than the gypsum core.

In an embodiment, the gypsum-based construction material may comprise a particular thickness that may facilitate improved performance and/or manufacturing of the gypsum-based construction material. In an embodiment, the thickness may be at least 5.0 mm. In an embodiment, the thickness may be less than 30 mm. Alternatively, the thickness may be at least 0.19 in. and not greater than 1.2 in. It will be appreciated that the thickness may be between any of the minimum and maximum values noted above.

In an embodiment, the gypsum-based construction material may comprise a particular density that may facilitate improved performance and/or manufacturing of the gypsum-based construction material. In an embodiment, the density may be at least 1250 lbs./msf. In an embodiment, the density may be less than 3150 lbs./msf. It will be appreciated that the density may be between any of the minimum and maximum values noted above.

In an embodiment, the gypsum-based construction material may have a particular flexural strength. In an embodiment, the flexural strength may be at least 30.0 lbf or at least 31.0 lbf or at least 31.5 lbf or at least 32.0 lbf or at least 32.5 lbf or at least 33.0 lbf or at least 33.5 lbf or at least 34.0 lbf or at least 34.5 lbf or at least 35.0 lbf or at least 35.5 lbf or at least 36.0 lbf or at least 36.5 lbf or at least 37.0 lbf or at least 37.5 lbf or at least 38.0 lbf or at least 38.5 lbf. In an embodiment, the flexural strength may be no greater than 100 lbf. The flexural strength is measured according to the procedure outlined in the examples section of this application.

In an embodiment, the gypsum-based construction material can further include at least one liner. The liner may be a particular material that may facilitate improved performance and/or manufacturing of the gypsum-based construction material. In an embodiment, the liner may comprise a paper liner, a glass mat liner, or any combination thereof.

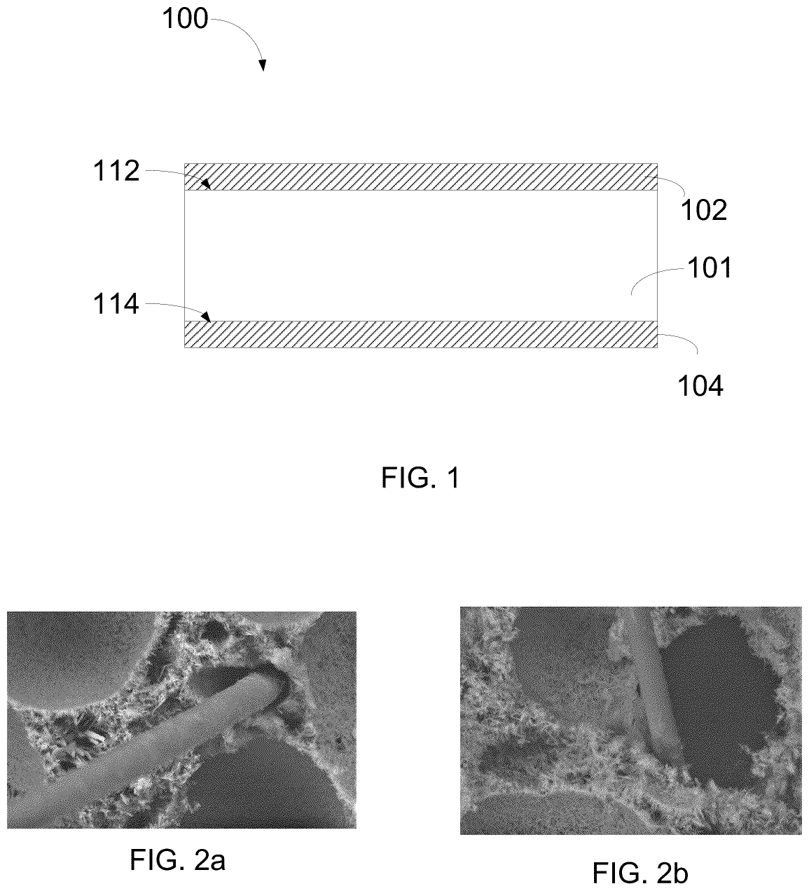

In an embodiment, the at least one liner can be present on a major surface of the gypsum-based construction material. In another embodiment, the gypsum-based construction material can include two liners present on opposing major surfaces. An example of such a gypsum board is shown in a cross-sectional schematic view in FIG. 1. Here, gypsum-based construction material (100) including a gypsum core (101) and a first liner (102) at a first major surface (112) of the gypsum core; a second liner (104) at a second, opposing major surface (114) of the gypsum core.

In an embodiment, the gypsum-based construction material can exhibit fire resistance.

### EMBODIMENTS

Embodiment 1. A gypsum-based slurry composition comprising:
a precursor stucco component,
a precursor reinforcement component comprising glass fibers coated with a glass fiber coating, the glass fiber coating comprising PVOH, PVAC, hydrophilic silane, or a combination thereof.

Embodiment 2. A gypsum-based construction material (preferably made by a method as defined in any one of embodiments 3 to 75 and 77 to 99) comprising a gypsum core, wherein the gypsum core comprises:
a gypsum component,
a reinforcement component comprising glass fibers coated with a glass fiber coating, the glass fiber coating comprising PVOH, PVAC, hydrophilic silane, or a combination thereof.

Embodiment 3. A method of forming a gypsum-based construction material, wherein the method comprises
providing a gypsum-based slurry composition (preferably as defined in any one of embodiments 1, 4 to 38 and 76 to 82) comprising:
a precursor stucco component,
a precursor reinforcement component comprising glass fibers coated with a glass fiber coating, the glass fiber coating comprising PVOH, PVAC, hydrophilic silane, or a combination thereof,
depositing the slurry composition to form a gypsum preform of the gypsum-based construction material preform, and
drying the gypsum preform of the gypsum-based construction material to form a gypsum core.

Embodiment 4. The gypsum-based slurry composition or method of any one of embodiments 1 and 3, wherein the glass fiber coating comprises a combination of PVOH and PVAC.

Embodiment 5. The gypsum-based slurry composition or method of any one of embodiments 1 and 3, wherein the glass fiber coating comprises hydrophilic silane.

Embodiment 6. The gypsum-based slurry composition or method of any one of embodiments 1 and 3 to 5, wherein the glass fiber coating comprises a coating slump factor S_{c} of greater than 0.98 in or at least 0.985 in. or at least 0.99 in.

Embodiment 7. The gypsum-based slurry composition or method of any one of embodiments 1 and 3 to 6, wherein the glass fiber coating comprises a coating slump factor S_{c} of not greater than 1.5 in.

Embodiment 8. The gypsum-based slurry composition or method of any one of embodiments 1 and 3 to 7, wherein the glass fiber coating comprises a coating contact angle factor C_{c} of no greater than 54° or no greater than 53.5° or no greater than 53° or no greater than 52.5° or no greater than 52° or no greater than 51.5° or no greater than 51°.

Embodiment 9. The gypsum-based slurry composition or method of any one of embodiments 1 and 3 to 8, wherein the glass fiber coating comprises a coating contact angle factor C_{c} of at least 40°.

Embodiment 10. The gypsum-based slurry composition or method of any one of embodiments 1 and 3 to 9, wherein the gypsum-based slurry composition comprises a slurry slump factor Sₛ of at least 9.3 in. or at least 9.35 in. or at least 9.4 in. or at least 9.45 in. or at least 9.5 in. or at least 9.55 in. or at least 9.6 in.

Embodiment 11. The gypsum-based slurry composition or method of any one of embodiments 1 and 3 to 10, wherein the gypsum-based slurry composition comprises a slurry slump factor Sₛ of not greater than 10 in.

Embodiment 12. The gypsum-based slurry composition or method of any one of embodiments 1 and 3 to 11, wherein the gypsum-based slurry composition comprises the precursor reinforcement component at a content of at least about 0.03 wt. % relative to the content of the precursor stucco component.

Embodiment 13. The gypsum-based slurry composition or method of any one of embodiments 1 and 3 to 12, wherein the gypsum-based slurry composition comprises the precursor reinforcement component at a content of not greater than about 10 wt. % relative to the content of the precursor stucco component.

Embodiment 14. The gypsum-based slurry composition or method of any one of embodiments 1 and 3 to 13, wherein the precursor stucco component comprises calcium sulfate hemihydrate.

Embodiment 15. The gypsum-based slurry composition or method of any one of embodiments 1 and 3 to 14, wherein the gypsum-based slurry composition comprises the precursor stucco component at a content of at least about 10 wt. % for a total weight of the gypsum-based slurry composition.

Embodiment 16. The gypsum-based slurry composition or method of any one of embodiments 1 and 3 to 5, wherein the gypsum-based slurry composition comprises the precursor stucco component at a content of not greater than about 95 wt. % for a total weight of the gypsum-based slurry composition or not greater than about 90 wt. % or not greater than about 80 wt. % or not greater than about 70 wt. % or not greater than about 60 wt. % or not greater than about 50 wt. %.

Embodiment 17. The gypsum-based slurry composition or method of any one of embodiments 1 and 3 to 16, wherein the gypsum-based slurry further comprises a second precursor reinforcement component.

Embodiment 18. The gypsum-based slurry composition or method of embodiment 17, wherein the second precursor reinforcement component comprises glass fiber.

Embodiment 19. The gypsum-based slurry composition or method of embodiment 17 or 18, wherein the gypsum-based slurry composition comprises the second precursor reinforcement component at a content of at least about 0.03 wt. % relative to the content of the precursor stucco component.

Embodiment 20. The gypsum-based slurry composition or method of any one of embodiments 17 to 19, wherein the gypsum-based slurry composition comprises the second precursor reinforcement component at a content of not greater than about 10 wt. % relative to the content of the precursor stucco component.

Embodiment 21. The gypsum-based slurry composition or method of any one of embodiments 1 and 3 to 21, wherein the gypsum-based slurry further comprises a precursor starch component.

Embodiment 22. The gypsum-based slurry composition or method of embodiment 21, wherein the precursor starch component comprises an acid modified starch, a chemically modified starch, a natural starch, such as, a corn starch, a sorghum starch, a wheat starch, a tapioca starch, a rice starch, a pea starch, a potato starch, a maize starch, or any combination thereof.

Embodiment 23. The gypsum-based slurry composition or method of embodiment 21 or 22, wherein the gypsum-based slurry composition comprises the precursor starch component at a content of at least about 0.001 wt. % relative to the content of the precursor stucco component.

Embodiment 24. The gypsum-based slurry composition or method of any one of embodiments 21 to 23, wherein the gypsum-based slurry composition comprises the precursor starch component at a content of not greater than about 1.5 wt. % relative to the content of the precursor stucco component.

Embodiment 25. The gypsum-based slurry composition or method of any one of embodiments 1 and 3 to 24, wherein the gypsum-based slurry further comprises a precursor accelerator component.

Embodiment 26. The gypsum-based slurry composition or method of embodiment 25, wherein the precursor accelerator component comprises a heat resistant gypsum accelerator.

Embodiment 27. The gypsum-based slurry composition or method of embodiment 25 or 26, wherein the gypsum-based slurry composition comprises the precursor accelerator component at a content of at least about 0.1 wt. % relative to the content of the precursor stucco component.

Embodiment 28. The gypsum-based slurry composition or method of any one of embodiments 25 to 27, wherein the gypsum-based slurry composition comprises the precursor accelerator component at a content of not greater than about 5.0 wt. % relative to the content of the precursor stucco component.

Embodiment 29. The gypsum-based slurry composition or method of any one of embodiments 1 and 3 to 28, wherein the gypsum-based slurry further comprises a precursor guar gum component.

Embodiment 30. The gypsum-based slurry composition or method of embodiment 29, wherein the precursor guar gum component comprises a native guar gum, a chemically modified guar gum, or any combination thereof.

Embodiment 31. The gypsum-based slurry composition or method of any one of embodiments 1 and 3 to 30, wherein the gypsum-based slurry further comprises a fluidizing agent.

Embodiment 32. The gypsum-based slurry composition or method of embodiment 31, wherein the precursor fluidizing agent component comprises polynaphthalene sulfonate, ligno sulfonate, polyaryl ether, poly carboxylate or any combination thereof.

Embodiment 33. The gypsum-based slurry composition or method of embodiment 31 or 32, wherein the gypsum-based slurry composition comprises the precursor fluidizing agent component at a content of at least about 0.1 wt. % relative to the content of the precursor stucco component.

Embodiment 34. The gypsum-based slurry composition or method of any one of embodiments 31 to 33, wherein the gypsum-based slurry composition comprises the precursor fluidizing agent component at a content of not greater than about 1 wt. % relative to the content of the precursor stucco component.

Embodiment 35. The gypsum-based slurry composition or method of any one of embodiments 1 and 3 to 34, wherein the gypsum-based slurry further comprises water.

Embodiment 36. The gypsum-based slurry composition or method of any one of embodiments 1 and 3 to 35, wherein the gypsum-based slurry further comprises a precursor retardant component.

Embodiment 37. The gypsum-based slurry composition or method of any one of embodiments 1 and 3 to 36, wherein the gypsum-based slurry further comprises a precursor foam component.

Embodiment 38. The gypsum-based slurry composition or method of any one of embodiments 1 and 3 to 37, wherein the foaming agent is selected from the group consisting of alkyl ether sulfate, ethoxylated surfactant or lauryl surfactants.

Embodiment 39. The method of any one of embodiments 3 to 38, further comprising depositing a second gypsum-based slurry composition over the gypsum-based slurry composition.

Embodiment 40. The method of embodiment 39, wherein the second gypsum-based slurry composition comprises a second precursor stucco component and water.

Embodiment 41. The method of embodiment 40, wherein the second precursor stucco component comprises calcium sulfate hemihydrate.

Embodiment 42. The method of embodiment 40 or 41, wherein the second gypsum-based slurry composition comprises the second precursor stucco component at a content of at least about 10 wt. % for a total weight of the second gypsum-based slurry composition.

Embodiment 43. The method of any one of embodiments 40 to 42, wherein the second gypsum-based slurry composition comprises the second precursor stucco component at a content of not greater than about 95 wt. % for a total weight of the gypsum-based slurry composition or not greater than about 90 wt. % or not greater than about 80 wt. % or not greater than about 70 wt. % or not greater than about 60 wt. % or not greater than about 50 wt. %.

Embodiment 44. The method of any one of embodiments 40 to 43, wherein the second gypsum-based slurry composition comprises a third reinforcement component.

Embodiment 45. The method of embodiment 44, wherein the third reinforcement component comprises glass fibers.

Embodiment 46. The method of embodiment 44 or 45, wherein the third reinforcement component further comprises a third glass fiber coating comprising PVOH, PVAC, hydrophilic silane, or a combination thereof.

Embodiment 47. The method of any one of embodiments 44 to 46, wherein the third glass fiber coating comprises a combination of PVOH and PVAC.

Embodiment 48. The method of any one of embodiments 44 to 47, wherein the third glass fiber coating comprises hydrophilic silane.

Embodiment 49. The method of any one of embodiments 44 to 48, wherein the third glass fiber coating comprises a coating slump factor S_{c} of greater than 0.98 in or at least 0.985 in. or at least 0.99 in.

Embodiment 50. The method of any one of embodiments 44 to 49, wherein the third glass fiber coating comprises a coating slump factor S_{c} of not greater than 1.5 in.

Embodiment 51. The method of any one of embodiments 44 to 50, wherein the third glass fiber coating comprises a coating contact angle factor C_{c} of no greater than 54° or no greater than 53.5° or no greater than 53° or no greater than 52.5° or no greater than 52° or no greater than 51.5° or no greater than 51°.

Embodiment 52. The method of any one of embodiments 44 to 51 wherein the third glass fiber coating comprises a coating contact angle factor C_{c} of at least 40°.

Embodiment 53. The method of any one of embodiments 39 to 52, wherein the second gypsum-based slurry composition comprises a slurry slump factor Sₛ of at least 9.3 in. or at least 9.35 in. or at least 9.4 in. or at least 9.45 in. or at least 9.5 in. or at least 9.55 in. or at least 9.6 in.

Embodiment 54. The method of any one of embodiments 39 to 53, wherein the second gypsum-based slurry composition comprises a slurry slump factor Sₛ of not greater than 10 in.

Embodiment 55. The method of any one of embodiments 44 to 54, wherein the second gypsum-based slurry composition comprises the third precursor reinforcement component at a content of at least about 0.03 wt. % relative to the content of the second precursor stucco component.

Embodiment 56. The method of any one of embodiments 44 to 55, wherein the second gypsum-based slurry composition comprises the third precursor reinforcement component at a content of not greater than about 10 wt. % relative to the content of the second precursor stucco component.

Embodiment 57. The method of any one of embodiments 39 to 56, wherein the second gypsum-based slurry composition comprises a fourth reinforcement component.

Embodiment 58. The method of embodiment 57, wherein the fourth reinforcement component comprises glass fibers.

Embodiment 59. The method of embodiment 57 or 58, wherein the second gypsum-based slurry composition comprises the fourth precursor reinforcement component at a content of at least about 0.03 wt. % relative to the content of the second precursor stucco component.

Embodiment 60. The method of any one of embodiments 57 to 59, wherein the second gypsum-based slurry composition comprises the fourth precursor reinforcement component at a content of not greater than about 10 wt. % relative to the content of the second precursor stucco component.

Embodiment 61. The method of any one of embodiments 39 to 60, wherein the second gypsum-based slurry composition comprises, a second precursor retardant component, a second precursor accelerator component, a second precursor fluidizing agent, a second precursor starch component, or a combination thereof.

Embodiment 62. The method of any one of embodiments 39 to 61, wherein the second gypsum-based slurry composition is denser than the gypsum-based slurry composition.

Embodiment 63. The method of any one of embodiments 39 to 62, wherein the second gypsum-based slurry composition does not comprise a foaming agent.

Embodiment 64. The method of any one of embodiments 39 to 63, wherein the second gypsum-based slurry composition is the same composition as the gypsum-based slurry composition.

Embodiment 65. The method of any one of embodiments 39 to 64, wherein the second gypsum-based slurry composition is a different composition than the gypsum-based slurry composition.

Embodiment 66. The method of any one of embodiments 39 to 65, wherein the second gypsum-based slurry composition is the same composition as the gypsum-based slurry composition without the foaming agent.

Embodiment 67. The method of any one of embodiments 3 to 66, wherein the gypsum core comprises a gypsum component, and a reinforcement component comprising glass fibers comprises coated with a glass fiber coating, the glass fiber coating comprising PVOH, PVAC, hydrophilic silane, or a combination thereof.

Embodiment 68. The gypsum-based construction material or method of any one of embodiments 2 and 67, wherein the glass fiber coating comprises a combination of PVOH and PVAC.

Embodiment 69. The gypsum-based construction material or method of any one of embodiments 2, 67, and 68, wherein the glass fiber coating comprises hydrophilic silane.

Embodiment 70. The gypsum-based construction material or method of any one of embodiments 2 and 67 to 69, wherein the glass fiber coating comprises a coating slump factor S_{c} of greater than 0.98 in or at least 0.985 in. or at least 0.99 in.

Embodiment 71. The gypsum-based construction material or method of any one of embodiments 2 and 67 to 70, wherein the glass fiber coating comprises a coating slump factor S_{c} of not greater than 1.5 in.

Embodiment 72. The gypsum-based construction material or method of any one of embodiments 2 and 67 to 71, wherein the glass fiber coating comprises a coating contact angle factor C_{c} of no greater than 54° or no greater than 53.5° or no greater than 53° or no greater than 52.5° or no greater than 52° or no greater than 51.5° or no greater than 51°.

Embodiment 73. The gypsum-based construction material or method of any one of embodiments 2 and 67 to 72, wherein the glass fiber coating comprises a coating contact angle factor C_{c} of at least 40°.

Embodiment 74. The gypsum-based construction material or method of any one of embodiments 2 and 67 to 73, wherein the gypsum core comprises the gypsum component at a content of at least about 60 wt. % for a total weight of the gypsum core.

Embodiment 75. The gypsum-based construction material or method of any one of embodiments 2 and 67 to 74, wherein the gypsum core comprises the gypsum component at a content of not greater than about 98 wt. % for a total weight of the gypsum core.

Embodiment 76. The gypsum-based slurry composition of embodiment 1 and 4 to 38, wherein the gypsum-based slurry is casted to form a gypsum-based construction material, such as, a panel, a board, walls, plinths, slabs, columns, sheets, casts or shafts.

Embodiment 77. The gypsum-based slurry composition, gypsum-based construction material or method of any one of embodiments 1 to 76, wherein the construction material has a thickness of at least 5.0 mm.

Embodiment 78. The gypsum-based slurry composition, gypsum-based construction material or method of any one of embodiments 1 to 77, wherein the construction material has a thickness of no greater than 30 mm.

Embodiment 79. The gypsum-based slurry composition, gypsum-based construction material or method of any one of embodiments 1 to 78, wherein the construction material has a flexural strength of at least 30.0 lbf or at least 31.0 lbf or at least 31.5 lbf or at least 32.0 lbf or at least 32.5 lbf or at least 33.0 lbf or at least 33.5 lbf or at least 34.0 lbf or at least 34.5 lbf or at least 35.0 lbf or at least 35.5 lbf or at least 36.0 lbf or at least 36.5 lbf or at least 37.0 lbf or at least 37.5 lbf or at least 38.0 lbf or at least 38.5 lbf.

Embodiment 80. The gypsum-based slurry composition, gypsum-based construction material or method of any one of embodiments 1 to 79, wherein the construction material has a flexural strength of no greater than 100 lbf.

Embodiment 81. The gypsum-based slurry composition, gypsum-based construction material or method of any one of embodiments 1 to 80, wherein the construction material has a density of at least 1250 lbs./msf.

Embodiment 82. The gypsum-based slurry composition, gypsum-based construction material or method of any one of embodiments 1 to 81, wherein the construction material has a density of less than 3150 lbs./msf.

Embodiment 83. The gypsum-based construction material or method of any one of embodiments 2 to 75, wherein the gypsum-based construction material further comprises at least one liner.

Embodiment 84. The gypsum-based construction material or method of embodiment 83, wherein the at least one liner comprises a paper liner, a glass mat liner, or any combination thereof.

Embodiment 85. The gypsum-based construction material or method of any one of embodiments 2 to 75, 83, and 84, wherein the gypsum-based construction material exhibits fire resistance.

Embodiment 86. The gypsum-based construction material or method of any one of embodiments 2 to 75, 83 to 85, wherein the gypsum-based construction material comprises a second gypsum layer comprising a second gypsum component.

Embodiment 87. The gypsum-based construction material or method of embodiment 86, wherein the second gypsum layer composition comprises a third reinforcement component.

Embodiment 88. The gypsum-based construction material or method of embodiment 87, wherein the third reinforcement component comprises glass fibers.

Embodiment 89. The gypsum-based construction material or method of embodiment 88, wherein the third reinforcement component further comprises a third glass fiber coating comprising PVOH, PVAC, hydrophilic silane, or a combination thereof.

Embodiment 90. The gypsum-based construction material or method of embodiment 89, wherein the third glass fiber coating comprises a combination of PVOH and PVAC.

Embodiment 91. The gypsum-based construction material or method of embodiment 89, wherein the third glass fiber coating comprises hydrophilic silane.

Embodiment 92. The gypsum-based construction material or method of any one of embodiments 89 to 91, wherein the third glass fiber coating comprises a coating slump factor S_{c} of greater than 0.98 in or at least 0.985 in. or at least 0.99 in.

Embodiment 93. The gypsum-based construction material or method of any one of embodiments 89 to 92, wherein the third glass fiber coating comprises a coating slump factor S_{c} of not greater than 1.5 in.

Embodiment 94. The gypsum-based construction material or method of any one of embodiments 89 to 93, wherein the third glass fiber coating comprises a coating contact angle factor C_{c} of no greater than 54° or no greater than 53.5° or no greater than 53° or no greater than 52.5° or no greater than 52° or no greater than 51.5° or no greater than 51°.

Embodiment 95. The gypsum-based construction material or method of any one of embodiments 89 to 94, wherein the third glass fiber coating comprises a coating contact angle factor C_{c} of at least 40°.

Embodiment 96. The method of any one of embodiments 87 to 95, wherein the second gypsum layer composition comprises the third precursor reinforcement component at a content of at least about 0.03 wt. % relative to the content of the second gypsum component.

Embodiment 97. The method of any one of embodiments 87 to 96, wherein the second layer comprises the third precursor reinforcement component at a content of not greater than about 10 wt. % relative to the content of the second gypsum component.

Embodiment 98. The gypsum-based construction material or method of any one of embodiments 86 to 97, wherein the second layer comprises a fourth reinforcement component, a second retardant component, a second accelerator component, a second fluidizing agent, a second starch component, or a combination thereof.

Embodiment 99. The gypsum-based construction material or method of any one of embodiments 86 to 98, wherein the second gypsum layer is denser than the gypsum core.

### EXAMPLES

### Example 1—Preparation of Gypsum Boards and Flexural Strength Testing

The following non-limiting examples illustrate the present invention.

Samples S1-S5 and comparative samples CS1-CS3 were prepared according to the process below and the compositions in Table 1. To prepare the boards, 500 g stucco was mixed with, 18-22 g of 1% retardant in water solution (0.03-0.5 wt. % retardant based on the weight of the stucco), 310-350 g water (about 350 g water total with the retardant solution), 0.5-1.5 g glass fiber (0.1-0.3 wt. % based on the weight of the stucco), 1-2 g starch (0.20-0.40 wt. % based on the weight of the stucco), 1-3 g of a gypsum accelerator (0.20-0.60 wt. % based on the weight of the stucco), 1-2 g of fluidizer (0.20-0.40 wt. % based on the weight of the stucco), and a foaming agent. Glass fiber coatings for each sample are according to Table 1 below.

Gypsum cores were then formed by allowing the gypsum slurry to set and then dry to remove excess water.” Each board was ⅝ inches thick. Boards were cut into 4×20 cm samples and conditioned at 23° C. and 50% humidity at least 24 hours. Samples were then tested according to a modified version of ASTM C473 as follows. An Instron press (Instron 4482 is prepped using the 5 kN load cell and is calibrated. The top and bottom fixtures are smaller, the distance between supports was 17.4 cm and the radius of each part was 4 mm. A load is applied midway by a top support having a diameter of 10 mm. The maximum force required to break the sample is recorded. Results can be found in Table 1 below.

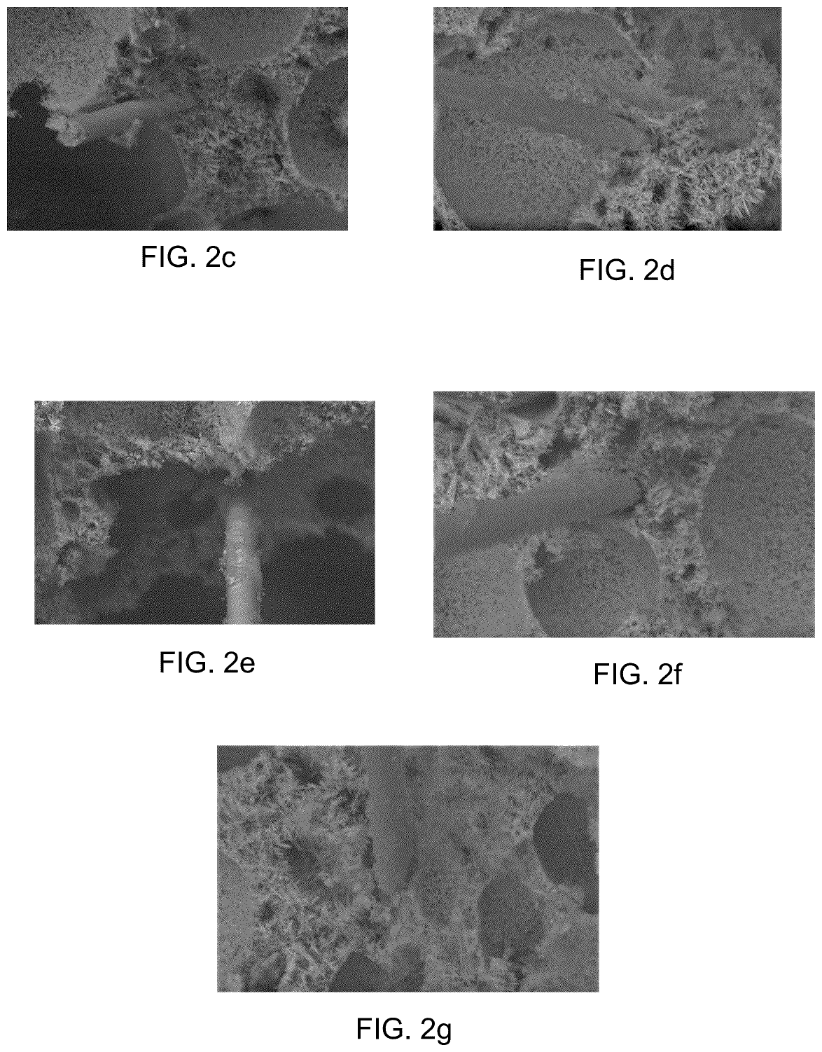

TABLE 1

| Sample | Fiber Coating | Flex Strength (lbf) | Interface |
|---|---|---|---|
| CS1 | No fibers | 34.1 | |
| CS2 | Hydrophobic Silane 1 | 32.5 | FIG. 2a |
| CS3 | Hydrophobic Silane 2 | 35.5 | FIG. 2b |
| S1 | PVOH PVAC 1 | 43.2 | FIG. 2c |
| S2 | PVOH PVAC 2 | 38.9 | FIG. 2d |
| S3 | PVOH PVAC 3 | 45.6 | FIG. 2e |
| S4 | Hydrophilic Silane 1 | 45.5 | FIG. 2f |
| S5 | Hydrophilic Silane 2 | 43.1 | FIG. 2g |

Images of the gypsum boards focused on the interface between the glass fiber sizings and gypsum were taken at 600× magnification for samples CS2, CS3 and S1-S5 and can be found in FIGS. 2a-g.

### Example 2—Gypsum Slurry Slump Factor

Slurries according to samples CS3, S3, and S4 were prepared according to the process in example 1 above. Slurries were deposited placed in a metal cylinder having a diameter of 2″ and a height of 4″ placed in the center of a glass plate. Enough slurry was deposited to fully fill the cylinder. Then, the cylinder was lifted straight up off the plate, allowing the slurry to spread across the glass plate. 4 diameter measurements were taken and averaged. Results can be found below in Table 2.

TABLE 2

| Sample | Fiber Coating | Slurry Slump factor |
|---|---|---|
| CS3 | Hydrophobic Silane 2 | 9.25 in. |
| S3 | PVOH PVAC 3 | 9.75 in. |
| S4 | Hydrophilic Silane 1 | 9.62 in. |

### Example 3—Setting Time

Setting time as measured by temperature rise set (TRS) was recorded according to the following process. A Type K penetration probe with response time <2 s: (e.g., Dig-Sense probe (length 5″, diameter 0.093″) from Cole Parmer ref: EW-08516-55) was inserted into a polystyrene lid that fits into an 8 oz polystyrene cup such that the probe will be inside the cup when the lid is placed on the cup. The probe was plugged into a Data logger for type K thermocouple with 1 s recording frequency (e.g., national instrument USB ref: USB-TC01).

Slurries according to samples CS3, S3, and S4 were prepared according to the process in example 1 above. Once the dry ingredients touch the wet ingredients, a timer is started. The slurry was placed in the styrene cup. The cup lid was then immediately closed, with the probe vertically oriented inside the slurry. The temperature is measured in 1 second intervals until the temperature begins to decrease. The 50% hydration time (time after which 50% of the stucco is converted to gypsum) is estimated according to the temperature data collected and standard industry practice. Results may be found in Table 3 below.

TABLE 3

| Sample | Fiber Coating | 50% hydration time |
|---|---|---|
| CS3 | Hydrophobic Silane 2 | 450 sec |
| S3 | PVOH PVAC 3 | 454 sec |
| S4 | Hydrophilic Silane 1 | 458 sec |

### Example 4—Coating Slump Factor and Contact Testing

Glass plates with thin coatings of the coatings used in samples CS3, S3, and S4 above. 500 g stucco was mixed with, 18-22 g of 1% retardant in water solution (0.03-0.5 wt. % retardant based on the weight of the stucco), 310-350 g water (about 350 g water total with the retardant solution). 1 mL solution of the slurry is pipetted onto each glass plate and the diameter is measured using a 0.1 mm precision ruler. 25 μL of water is pipetted onto each glass plate and the contact angle (also herein referred to as a contact angle factor) is measured. Results can be found below in Table 4.

TABLE 4

| | | Coating | Coating | |
|---|---|---|---|---|
| | | Slump | Slump | Contact |
| Sample | Fiber Coating | factor run 1 | factor run 2 | angle |
| CS3a | Hydrophobic Silane | 0.92-0.95 in. | 0.98 in. | 55.96 ± 1.82 |
| | 2 | | | |
| S3a | PVOH PVAC 3 | 1.05-1.1 in. | 1.02 in. | 48.92 ± 2.15 |
| S4a | Hydrophilic Silane | 1.1 in. | 1 in. | 46.24 ± 1.25 |
| | 1 | | | |

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A gypsum-based slurry composition comprising:
a precursor stucco component,
a precursor reinforcement component comprising glass fibers coated with a glass fiber coating, the glass fiber coating comprising PVOH, PVAC, hydrophilic silane, or a combination thereof.

2. The gypsum-based slurry composition of claim 1, wherein the glass fiber coating comprises a combination of PVOH and PVAC.

3. The gypsum-based slurry composition of claim 1, wherein the glass fiber coating comprises hydrophilic silane.

4. The gypsum-based slurry composition of claim 1, wherein the glass fiber coating comprises a coating slump factor S_{c} of greater than 0.98 in and not greater than 1.5.

5. The gypsum-based slurry composition of claim 1, wherein the glass fiber coating comprises a coating contact angle factor C_{c} of no greater than 54° and at least 40°.

6. The gypsum-based slurry composition of claim 1, wherein the gypsum-based slurry composition comprises a slurry slump factor Sₛ of at least 9.3 in and not greater than 10 in.

7. A gypsum-based construction material comprising a gypsum core, wherein the gypsum core comprises:
a gypsum component,
a reinforcement component comprising glass fibers coated with a glass fiber coating, the glass fiber coating comprising PVOH, PVAC, hydrophilic silane, or a combination thereof.

8. The gypsum-based construction material of claim 7, wherein the glass fiber coating comprises a combination of PVOH and PVAC.

9. The gypsum-based construction material of claim 7, wherein the glass fiber coating comprises hydrophilic silane.

10. The gypsum-based construction material of claim 7, wherein the glass fiber coating comprises a coating slump factor S_{c} of greater than 0.98 in and not greater than 1.5.

11. The gypsum-based construction material of claim 7, wherein the glass fiber coating comprises a coating contact angle factor C_{c} of no greater than 54° and at least 40°.

12. The gypsum-based construction material of claim 7, wherein the gypsum-based slurry is casted to form a gypsum-based construction material, such as, a panel, a board, walls, plinths, slabs, columns, sheets, casts or shafts.

13. The gypsum-based construction material of claim 7, wherein the construction material has a flexural strength of at least 30.0 lbf and no greater than 100 lbf.

14. The gypsum-based construction material of claim 7, wherein the construction material has a density of at least 1250 lbs./msf and less than 3150 lbs./msf.

15. A method of forming a gypsum-based construction material, wherein the method comprises
providing a gypsum-based slurry composition comprising:
a precursor stucco component,
a precursor reinforcement component comprising glass fibers coated with a glass fiber coating, the glass fiber coating comprising PVOH, PVAC, hydrophilic silane, or a combination thereof,
depositing the slurry composition to form a gypsum preform of the gypsum-based construction material preform, and
drying the gypsum prefrom of the gypsum-based construction material to form a gypsum core.

16. The method of claim 15, wherein the glass fiber coating comprises a combination of PVOH and PVAC.

17. The method of claim 15, wherein the glass fiber coating comprises hydrophilic silane.

18. The method of claim 15, wherein the glass fiber coating comprises a coating slump factor S_{c} of greater than 0.98 in and not greater than 1.5.

19. The method of claim 15, wherein the glass fiber coating comprises a coating contact angle factor C_{c} of no greater than 54° and at least 40°.

20. The method of claim 15, wherein the gypsum-based slurry composition comprises a slurry slump factor Sₛ of at least 9.3 in and not greater than 10 in.
